(19) United States
(12) Patent Application Publication
(10) Pub. No.: US 2026/0187868 A1
(43) Pub. Date: Jul. 2, 2026

(54) METHOD, SYSTEM, AND TERMINAL FOR SPATIO-TEMPORAL KERNEL DENSITY VISUALIZATION BASED ON PREFIX MATRIX

(71) Applicant: SHENZHEN UNIVERSITY, Shenzhen (CN)

(72) Inventors: Tsz Nam CHAN, Shenzhen (CN); Pak Lon IP, Taipa (CN); Bojian ZHU, Hong Kong (CN); Leong Hou U, Taipa (CN); Dingming WU, Shenzhen (CN); Jianliang XU, Hong Kong (CN); Christian S. JENSEN, Aalborg East (DK)

(73) Assignee: SHENZHEN UNIVERSITY, Shenzhen (CN)

(21) Appl. No.: 19/372,467

(22) Filed: Oct. 29, 2025

(30) Foreign Application Priority Data
Dec. 31, 2024 (CN) 202411977346.7

(51) Int. Cl. G06T 11/00; G06T 11/20

(52) U.S. Cl. CPC G06T 11/10; G06T 11/26

(57) ABSTRACT

A method, a system, and a terminal for spatio-temporal kernel density visualization based on a prefix matrix are provided. The method includes determining multiple timestamps according to user input constraint information, determining corresponding time axes, and determining multiple temporal bandwidths on each time axis; obtaining pixel set within a target region to construct spatio-temporal data point sets corresponding to the timestamps, and generating multiple prefix matrices; constructing window matrices based on the prefix matrices to calculate the spatio-temporal kernel density of the target region; and coloring the pixel sets to obtain a visualization result of the spatio-temporal kernel density. By using the prefix structure, the method enables spatio-temporal kernel density visualization with reduced computational time complexity while maintaining reasonable space complexity, and improves visualization efficiency by considering both temporal and spatial dimensions.

### CROSS-REFERENCE TO RELATED APPLICATIONS

The present application claims priority to Chinese Patent Application No. 202411977346.7, filed on Dec. 31, 2024, the content of all of which is incorporated herein by reference.

### FIELD

The present disclosure relates to the technical field of geographic information science, and in particular to a method, a system, a terminal and a computer-readable storage medium for spatio-temporal kernel density visualization based on prefix matrix.

### BACKGROUND

Spatio-temporal kernel density visualization is a fundamental tool in geographic information systems and has been applied in various scenarios such as traffic hotspot detection, traffic accident hotspot detection, and epidemic hotspot detection, providing great convenience for information tracking.

However, spatio-temporal kernel density visualization is a relatively slow tool. Even the method with the currently smallest time complexity, namely the sliding-window-based solution (SWS), still suffers from slow processing speed. In addition, spatio-temporal kernel density visualization methods based on range queries exhibit relatively low efficiency. Furthermore, even for multi-threaded parallel approaches, the speed still cannot meet existing demands.

Therefore, the prior art still needs to be improved and developed.

### SUMMARY

The main purpose of the present disclosure is to provide a method, a system, a terminal and a computer-readable storage medium for spatio-temporal kernel density visualization based on prefix matrix, which is intended to improve the efficiency in spatio-temporal kernel density visualization in the prior art.

To achieve the above objective, the present disclosure provides a method for spatio-temporal kernel density visualization based on prefix matrix, which includes following steps:
Acquiring constraint information input by a user, determining a first preset group of timestamps according to the constraint information, determining a corresponding time axis according to each of the timestamps, and determining a second preset group of temporal bandwidths on each of the time axes according to the constraint information;
Obtaining a pixel set corresponding to each timestamp in a target region, and constructing a plurality of prefix matrices according to each pixel set and all the temporal bandwidths on each time axis;
Constructing a plurality of window matrices according to the plurality of prefix matrices, and calculating a spatio-temporal kernel density of the target region according to all the window matrices; and
Coloring each pixel-timestamp pair in the pixel set to obtain a spatio-temporal kernel density visualization result of the target region.

Optionally, in the method for spatio-temporal kernel density visualization based on prefix matrix, the step of acquiring constraint information input by a user, determining a first preset group of timestamps according to the constraint information, determining a corresponding time axis according to each of the timestamps, and determining a second preset group of temporal bandwidths on each of the time axes according to the constraint information, further includes:
Acquiring constraint information input by a user, the constraint information is configured to define a quantity of timestamps in the target region, and a quantity of spatial bandwidths and temporal bandwidths for each timestamp;
Determining the first preset group of timestamps in the target region according to the constraint information, and determining the corresponding time axis according to each of the timestamps; and
Determining the second preset group of temporal bandwidths and a third preset group of spatial bandwidths on each of the time axes according to the constraint information.

Optionally, in the method for spatio-temporal kernel density visualization based on prefix matrix, the step of determining the second preset group of temporal bandwidths and a third preset group of spatial bandwidths on each of the time axes according to the constraint information, further includes:
Fixing a single spatial bandwidth, and determining the second preset group of temporal bandwidths on each of the time axes according to the second preset group of temporal bandwidths; and
Determining a fourth preset group of endpoints according to all the temporal bandwidths.

Optionally, in the method for spatio-temporal kernel density visualization based on prefix matrix, the step of obtaining a pixel set corresponding to each timestamp in a target region, and constructing a plurality of prefix matrices according to each pixel set and all the temporal bandwidths on each time axis, further includes:
Obtaining a pixel set corresponding to each timestamp in the target region, and extracting all pixels in each pixel set;
Constructing a plurality of pixel-timestamp pairs according to all the pixels and the fourth preset group of endpoints on each of the time axes; and
Constructing a prefix matrix corresponding to each endpoint according to all the pixel-timestamp pairs:

$${S}_{\hat{P} ( {t}^{( v )} )}^{( u )} ( q ) = {\sum }_{( p , {t}_{p} ) ∈ \hat{P} ( {t}^{( v )} )} {t}_{p}^{u} \cdot {K}_{space} ( q , p ) ;$$

$$\hat{P} ( {t}^{( v )} ) = \{ ( p , {t}_{p} ) ∈ \hat{P} : {t}_{p} \leq {t}^{( v )} \} ;$$

Among them, q represents a pixel position of the prefix matrix, \hat{P} represents an entire spatio-temporal data point set, (p, tₚ) represents a data point in \hat{P}, t^{(v)} represents a timestamp corresponding to the v-th pixel-timestamp pair, v represents a quantity of timestamps, u represents a constant whose value is determined by a temporal kernel function,

$${t}_{p}^{u}$$

represents tₚ raised to u-th power,

$${S}_{\hat{P} ( {t}^{( v )} )}^{( u )} ( q )$$

represents a prefix matrix of t^{(v)}-th timestamp, p represents a position of (p, tₚ), tₚ represents a timestamp of (p,tₚ), K_{space}(q,p) represents a spatial kernel function, and \hat{P}(t^{(v)}) represents a spatio-temporal data point set that tₚ≤t^{(v)}.

Optionally, in the method for spatio-temporal kernel density visualization based on prefix matrix, the step of constructing a plurality of window matrices according to the plurality of prefix matrices, and calculating a spatio-temporal kernel density of the target region according to all the window matrices, further includes:

Constructing the plurality of window matrices according to the fourth preset group of prefix matrices on each time axis:

$${S}_{W ( {t}_{i} )}^{( u )} ( q ) = {S}_{\hat{P} ( {t}_{i} + {b}_{τ} )}^{( u )} ( q ) - {S}_{\hat{P} ( {t}_{i} - {b}_{τ} )}^{( u )} ( q ) ;$$

Among them,

$${S}_{W ( {t}_{i} )}^{( u )} ( q )$$

represents a window matrix used to calculate the spatio-temporal kernel density, u represents a constant whose value is determined by a temporal kernel function,

$${S}_{\hat{P} ( {t}_{i} + {b}_{τ} )}^{( u )} ( q ) and {S}_{\hat{P} ( {t}_{i} - {b}_{τ} )}^{( u )} ( q )$$

represent prefix matrices of two endpoints in tᵢ-th timestamp when temporal bandwidth is b_{τ}, b_{τ} represents a temporal bandwidth, and tᵢ represents a timestamp corresponding to i-th window matrix; and

Calculating the spatio-temporal kernel density of the target region based on all the window matrices:

$${\hat{P}}_{} ( q , {t}_{i} ) {\sum }_{( p , {t}_{p} ) ∈ \hat{P}} w \cdot {K}_{space} ( q , p ) \cdot ( 1 - \frac{1}{{b}_{τ}^{2}} {d ( {t}_{i} , {t}_{p} )}^{2} ) = w \cdot ( 1 - \frac{{t}_{i}^{2}}{{b}_{τ}^{2}} ) {S}_{W ( {t}_{i} )}^{( 0 )} ( q ) + \frac{2 {wt}_{i}}{{b}_{τ}^{2}} {S}_{W ( {t}_{i} )}^{( 1 )} ( q ) - \frac{w}{{b}_{τ}^{2}} {S}_{W ( {t}_{i} )}^{( 2 )} ( q ) ;$$

Among them, [symbol] _{\hat{P}}(q, tᵢ) represents a spatio-temporal kernel density of i-th timestamp, tₚ represents a timestamp of a spatio-temporal data point, d(tᵢ, tₚ) represents a Euclidean distance between tᵢ and tₚ, w represents a normalization constant,

$${S}_{W ( {t}_{i} )}^{( 0 )}$$

represents a window matrix that u equals to 0,

$${S}_{W ( {t}_{i} )}^{( 1 )}$$

represents a window matrix that u equals to 1, and

$${S}_{W ( {t}_{i} )}^{( 2 )}$$

represents a window matrix that u equals to 2.

Optionally, in the method for spatio-temporal kernel density visualization based on prefix matrix, after the step of constructing a plurality of window matrices according to the plurality of prefix matrices, and calculating a spatio-temporal kernel density of the target region according to all the window matrices, further includes:

Calculating a time complexity of the prefix matrix of endpoint on each of the time axis to obtain a first time complexity;

Calculating a time complexity of a plurality of prefix matrices corresponding to each of the time axes to obtain a second time complexity; and

Calculating a time complexity of a plurality of prefix matrices corresponding to each of the spatial bandwidths and each of the temporal bandwidths to obtain a third time complexity.

Optionally, in the method for spatio-temporal kernel density visualization based on prefix matrix, the step of coloring each pixel-timestamp pair in the pixel set to obtain a spatio-temporal kernel density visualization result of the target region, further includes:
Determining two prefix matrices corresponding to each window matrix according to a plurality of temporal bandwidths; and
Coloring each pixel-timestamp pair in the pixel set in each prefix matrix to obtain the spatio-temporal kernel density visualization result of the target region.

In addition, to achieve the above-mentioned purpose, the present disclosure further provides a system for spatio-temporal kernel density visualization based on prefix matrix, and the system for spatio-temporal kernel density visualization based on prefix matrix includes:
A bandwidth information determination module, configured to acquire constraint information input by a user, determine a first preset group of timestamps according to the constraint information, determine a corresponding time axis according to each of the timestamps, and determine a second preset group of temporal bandwidths on each of the time axes according to the constraint information;
A prefix matrix construction module, configured to obtain a pixel set corresponding to each timestamp in a target region, and construct a plurality of prefix matrices according to each pixel set and all the temporal bandwidths on each time axis;
A spatio-temporal kernel density calculation module, configured to construct a plurality of window matrices according to the plurality of prefix matrices, and calculate a spatio-temporal kernel density of the target region according to all the window matrices; and
A result visualization module, configured to color each pixel-timestamp pair in the pixel set to obtain a spatio-temporal kernel density visualization result of the target region.

In addition, to achieve the above-mentioned purpose, the present disclosure also provides a terminal, and the terminal includes: a memory, a processor, and a program for spatio-temporal kernel density visualization based on prefix matrix stored on the memory, the program is executable on the processor. When the program for spatio-temporal kernel density visualization based on prefix matrix is executed by the processor, the steps of the method for spatio-temporal kernel density visualization based on prefix matrix as described above are implemented.

In addition, to achieve the above-mentioned purpose, the present disclosure also provides a computer-readable storage medium, and the computer-readable storage medium stores a program for spatio-temporal kernel density visualization based on prefix matrix, and when the program for spatio-temporal kernel density visualization based on prefix matrix is executed by a processor, the steps of the method for spatio-temporal kernel density visualization based on prefix matrix as described above are implemented.

In the present disclosure, constraint information input by a user is acquired, a first preset group of timestamps is determined according to the constraint information, a corresponding time axis is determined for each of the timestamps, and, according to the constraint information, a second preset group of temporal bandwidths is determined on each of the time axes; a pixel set corresponding to each timestamp in a target region is then acquired, and a plurality of prefix matrices are constructed based on each pixel set and all the temporal bandwidths on each time axis; a plurality of window matrices are constructed based on the plurality of prefix matrices, and a spatio-temporal kernel density of the target region is calculated according to all of the window matrices; every pixel-timestamp pair in the pixel set is colored, thereby obtaining a spatio-temporal kernel density visualization result of the target region. Through the use of prefix structures, the present disclosure addresses the issues of exploratory analysis, conventional spatio-temporal kernel density visualization, and bandwidth tuning, then different numbers of prefix matrices are obtained and colored, thereby realizing spatio-temporal kernel density visualization. This reduces the time complexity during computation while ensuring a reasonable space complexity, and simultaneously takes into account both temporal and spatial dimensions, thus improving the efficiency of map visualization.

### BRIEF DESCRIPTION OF THE DRAWINGS

FIG. 1 is a flow chart of a method for spatio-temporal kernel density visualization based on prefix matrix according to an embodiment of the present disclosure;

FIG. 2 is a schematic diagram of a prefix matrix structure in the method for spatio-temporal kernel density visualization based on prefix matrix according to an embodiment of the present disclosure;

FIG. 3 is a schematic diagram of exploratory spatio-temporal kernel density visualization based on prefix matrix processing in the method for spatio-temporal kernel density visualization based on prefix matrix according to an embodiment of the present disclosure;

FIG. 4 is a schematic diagram of total response time of exploratory spatio-temporal kernel density visualization in the method for spatio-temporal kernel density visualization based on prefix matrix according to an embodiment of the present disclosure;

FIG. 5 is a schematic diagram of a spatio-temporal kernel density visualization result with three timestamps in the method for spatio-temporal kernel density visualization based on prefix matrix according to an embodiment of the present disclosure;

FIG. 6 is a schematic diagram of processing conventional spatio-temporal kernel density visualization based on prefix matrix in the method for spatio-temporal kernel density visualization based on prefix matrix according to an embodiment of the present disclosure;

FIG. 7 is a schematic diagram of total response time of conventional spatio-temporal kernel density visualization in the method for spatio-temporal kernel density visualization based on prefix matrix according to an embodiment of the present disclosure;

FIG. 8 is a schematic diagram of spatio-temporal kernel density visualization of processing fixed timestamps based on prefix matrix in the method for spatio-temporal kernel density visualization based on prefix matrix according to an embodiment of the present disclosure;

FIG. 9 is a schematic diagram of spatio-temporal kernel density visualization of processing a plurality of temporal bandwidths based on prefix matrix in the method for spatio-temporal kernel density visualization based on prefix matrix according to an embodiment of the present disclosure;

FIG. 10 is a schematic diagram of total response time of spatio-temporal kernel density visualization while calculating a plurality of temporal bandwidths with a fixed spatial bandwidth in the method for spatio-temporal kernel density visualization based on prefix matrix according to an embodiment of the present disclosure;

FIG. 11 is a schematic diagram of space overhead of exploratory spatio-temporal kernel density visualization in the method for spatio-temporal kernel density visualization based on prefix matrix according to an embodiment of the present disclosure;

FIG. 12 is a schematic diagram of space overhead of conventional spatio-temporal kernel density visualization in the method for spatio-temporal kernel density visualization based on prefix matrix according to an embodiment of the present disclosure;

FIG. 13 is a structural diagram of a system for spatio-temporal kernel density visualization based on prefix matrix according to an embodiment of the present disclosure;

FIG. 14 is a structural diagram of a terminal according to an embodiment of the present disclosure.

### DETAILED DESCRIPTION OF THE EMBODIMENTS

In order to make the purpose, technical solutions and advantages of the present disclosure more clear and distinct, the present disclosure is further described in detail below with reference to the accompanying drawings and embodiments. It should be understood that the embodiments described herein are only used to explain the present disclosure and are not intended to limit the present disclosure.

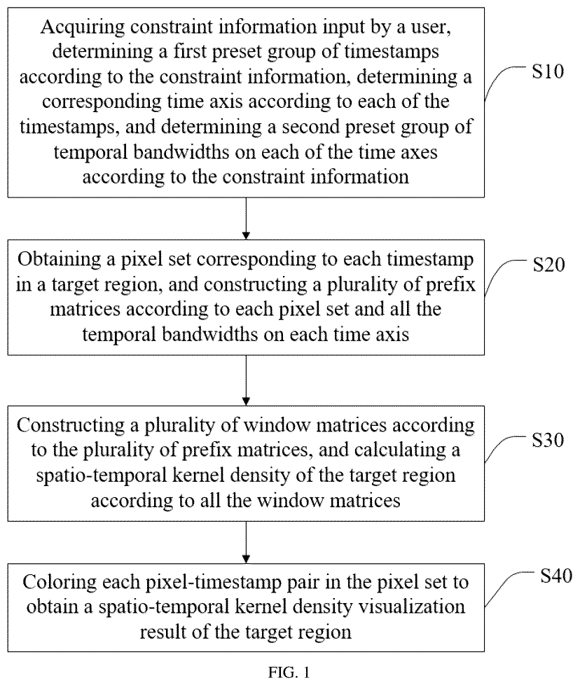

The method for spatio-temporal kernel density visualization based on prefix matrix according to an embodiment of the present disclosure is shown in FIG. 1. The method for spatio-temporal kernel density visualization based on prefix matrix includes the following steps:

Step S10: Acquiring constraint information input by a user, determining a first preset group of timestamps according to the constraint information, determining a corresponding time axis according to each of the timestamps, and determining a second preset group of temporal bandwidths on each of the time axes according to the constraint information.

For a data point set on a map given by the user (i.e., a target region), for a certain time point on the map (i.e., timestamp, such as a certain year, month, and day), a target image of the target region is generated (including X×Y pixels, i.e., a pixel set, where X represents a quantity of horizontal pixels and Y represents a quantity of vertical pixels). According to the present timestamp, a corresponding time axis (change of the data point set within a certain year, month, and day) is obtained, and a spatial kernel function bandwidth value (spatial bandwidth) and a temporal kernel function bandwidth value (temporal bandwidth) are introduced in the time axis. The spatio-temporal kernel density visualization of the target image can be calculated, and such process is exploratory spatio-temporal and density visualization.

Furthermore, if changes in a target region are observed over a long period of time, a plurality of timestamps (for example, T timestamps) can be obtained. With the variations in the target image, a corresponding target image can be obtained at each timestamp, and a plurality of time axes can be derived according to these timestamps. At this time, by introducing a spatial bandwidth and a temporal bandwidth with respect to the variations on all the time axes of the target region, the spatio-temporal kernel density visualization of the target image can be calculated.

For the step obtaining the constraint information input by the user, the constraint information is adopted to set the number of timestamps in the target region, and the amount of spatial bandwidth and temporal bandwidth on each timestamp; a first preset group of timestamps in the target region are determined according to the constraint information, and a corresponding time axis is determined according to each of the timestamps; and a second preset group of temporal bandwidths and a third preset group of spatial bandwidths are determined on each of the time axes according to the constraint information.

Furthermore, a single spatial bandwidth is fixed, and a second preset group of temporal bandwidths on each time axis are determined according to a second preset group of temporal bandwidths; and a fourth preset group of endpoints are determined according to all the temporal bandwidths.

The constraint information input by the user is obtained, and according to the constraint information, M spatial bandwidths (third preset group) and N temporal bandwidths (second preset group) can be determined. Based on the above steps, a spatial bandwidth is first fixed, and there are 2N endpoints for N temporal bandwidths. Therefore, according to the constraint information input by the user, it can be determined that when a spatial bandwidth is fixed, 2N endpoints on a certain time axis (i.e., corresponding to a certain timestamp) of the target region are determined, and then prefix matrices corresponding to each endpoint can be constructed (i.e., 2N prefix matrices can be constructed). Through this sweeping method, the efficiency of calculating the spatio-temporal kernel density function visualization can be effectively improved.

Step S20: Obtaining a pixel set corresponding to each timestamp in a target region, and constructing a plurality of prefix matrices according to each pixel set and all the temporal bandwidths on each time axis.

Pixel sets corresponding to each timestamp in the target region are obtained, and all pixels in each pixel set are extracted; a plurality of pixel-timestamp pairs are constructed based on all the pixels and a fourth preset group of endpoints on each time axis; and prefix matrices corresponding to each endpoint are constructed based on all the pixel-timestamp pairs:

$${S}_{\hat{P} ( {t}^{( v )} )}^{( u )} ( q ) = {\sum }_{( p , {t}_{p} ) ∈ \hat{P} ( {t}^{( v )} )} {t}_{p}^{u} \cdot {K}_{space} ( q , p ) ;$$

$$\hat{P} ( {t}^{( v )} ) = \{ ( p , {t}_{p} ) ∈ \hat{P} : {t}_{p} \leq {t}^{( v )} \} ;$$

$${K}_{space} ( q , p ) = \{ \begin{matrix}1 - \frac{1}{{b}_{σ}^{2}} {d ( q , p )}^{2} , if d ( q , p ) \leq {b}_{σ} \\ 0 , otherwise\end{matrix} ;$$

Among them, q represents a pixel position of the prefix matrix, \hat{P} represents an entire spatio-temporal data point set (i.e., the data point set of the entire temporal and spatial dimension within the target region), (p, tₚ) represents a data point in \hat{P}, t^{(v)} represents a timestamp corresponding to the v-th pixel-timestamp pair, v represents a quantity of timestamps, u represents a constant whose value is determined by a temporal kernel function,

$${t}_{p}^{u}$$

represents tₚ raised to u-th power,

$${S}_{\hat{P} ( {t}^{( v )} )}^{( u )} ( q )$$

represents a prefix matrix of t^{(v)}-th timestamp, p represents a position of (p, tₚ), tₚ represents a timestamp of (p, tₚ), K_{space}(q,p) represents a spatial kernel function, \hat{P}(t^{(v)}) represents a spatio-temporal data point set that tₚ≤t^{(v)}, and b_{σ} represents standard spatial bandwidth value.

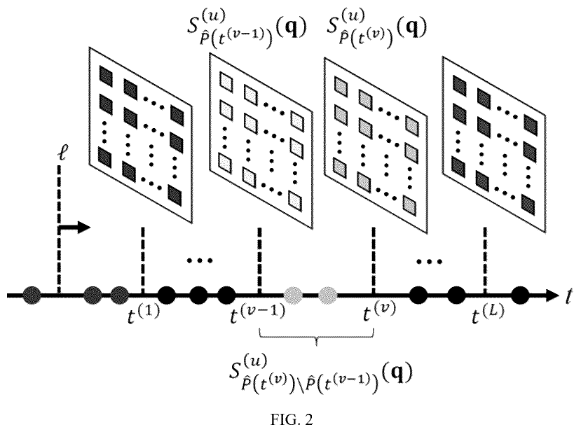

The pixel set in the target region at a certain timestamp is obtained, and pixel-timestamp pairs corresponding to each element in the pixel set can be constructed according to the spatial bandwidth and temporal bandwidth corresponding to this timestamp (according to the constraint information input by the user and a fixed spatial bandwidth, it can be determined that this timestamp in the current calculation process corresponds to one spatial bandwidth and N temporal bandwidths), thereby constructing the prefix matrix corresponding to this timestamp (as shown in FIG. 2) which includes L timestamps, and L prefix matrices are constructed correspondingly. Since there are M spatial bandwidths, the above steps need to be repeated M times.

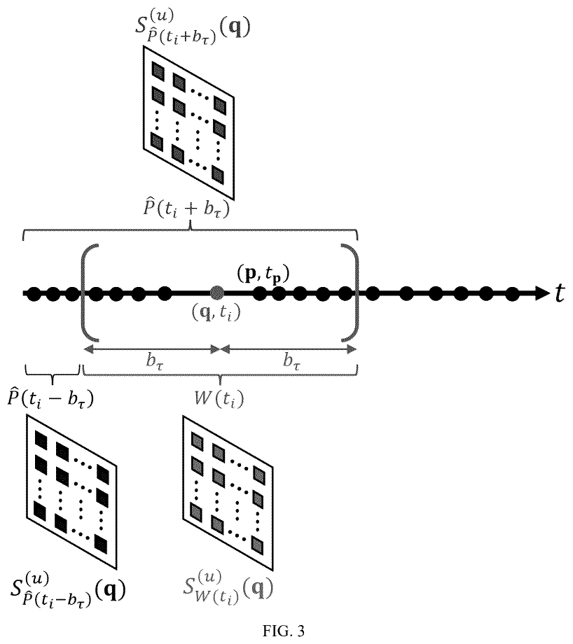

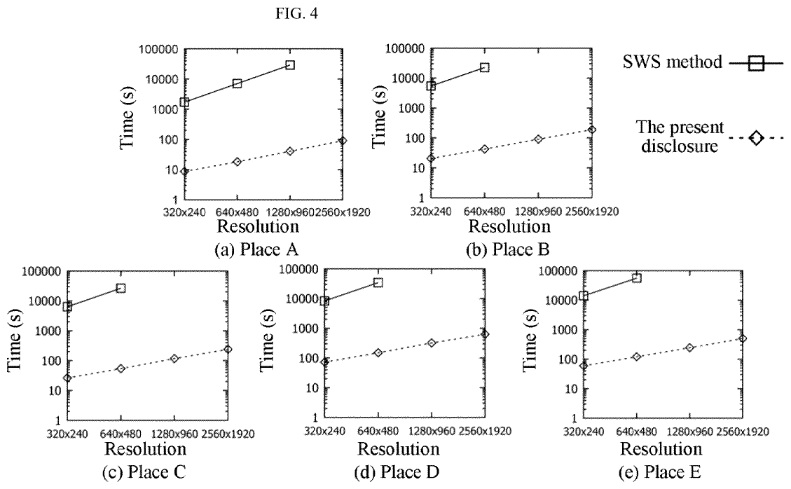

If a exploratory spatio-temporal kernel density visualization is calculated based on the data structure of the prefix matrix, as shown in FIG. 3 and FIG. 4, what is obtained is the total response time of the exploratory spatio-temporal kernel density visualization of the timestamp T=32 when the resolution X×Y is changed in different regions ((a) Place A, (b) Place B, (c) Place C, (d) Place D and (e) Place E in FIG. 4 represent different regions respectively). If a spatio-temporal kernel density corresponding to a prefix matrix at a certain timestamp is further calculated, and the pixel-timestamp pairs in the prefix matrix are colored, the visualization result shown in FIG. 5 is obtained, where (a) in FIG. 5 represents a spatio-temporal data point set at a certain place, (b) the first timestamp in FIG. 5, (c) the second timestamp in FIG. 5, and (d) the third timestamp in FIG. 5 represent the change of pixels in the local spatio-temporal data point set at different timestamps. If the time complexity and space complexity of the exploratory spatio-temporal kernel density visualization are further calculated, that is, calculating the time complexity of the prefix matrix at each of the timestamps (since the first research question only sets one temporal bandwidth and one spatial bandwidth, it is only necessary to construct two prefix matrices, corresponding to a window matrix), to obtain a first time complexity, the time complexity calculated based on the data structure of the prefix matrix can be obtained as O(Y(X+n)) (the first time complexity, where n represents the number of spatio-temporal data points), while the time complexity calculated by the SWS (Sliding-Window-based Solution, spatio-temporal kernel density visualization based on sliding windows) method in the prior art is O(XY+n), and the space complexity of the two is the same, both are O(XY+n). Therefore, the calculation process based on the prefix matrix takes into account both the temporal and spatial dimensions, and achieves the effect of efficiency optimization.

Step S30: Constructing a plurality of window matrices according to the plurality of prefix matrices, and calculating a spatio-temporal kernel density of the target region according to all the window matrices.

The plurality of window matrices are constructed according to the fourth preset group of prefix matrices on each time axis as:

$${S}_{W ( {t}_{i} )}^{( u )} ( q ) = {S}_{\hat{P} ( {t}_{i} + {b}_{τ} )}^{( u )} ( q ) - {S}_{\hat{P} ( {t}_{i} - {b}_{τ} )}^{( u )} ( q ) ;$$

Among them,

$${S}_{W ( {t}_{i} )}^{( u )} ( q )$$

represents a window matrix used to calculate the spatio-temporal kernel density, u represents a constant whose value is determined by a temporal kernel function,

$${S}_{\hat{P} ( {t}_{i} + {b}_{τ} )}^{( u )} ( q ) and {S}_{\hat{P} ( {t}_{i} - {b}_{τ} )}^{( u )} ( q )$$

represent prefix matrices of two endpoints in tᵢ-th timestamp when temporal bandwidth is b_{τ}, b_{τ} represents a temporal bandwidth, and tᵢ represents a timestamp corresponding to i-th window matrix.

The spatio-temporal kernel density of the target region is calculated based on all the window matrices:

$${\hat{P}}_{} ( q , {t}_{i} ) = {\sum }_{( p , {t}_{p} ) ∈ \hat{P}} w \cdot {K}_{space} ( q , p ) \cdot ( 1 - \frac{1}{{b}_{τ}^{2}} {d ( {t}_{i} , {t}_{p} )}^{2} ) = w \cdot ( 1 - \frac{{t}_{i}^{2}}{{b}_{τ}^{2}} ) {S}_{W ( {t}_{i} )}^{( 0 )} ( q ) + \frac{2 {wt}_{i}}{{b}_{τ}^{2}} {S}_{W ( {t}_{i} )}^{( 1 )} ( q ) - \frac{w}{{b}_{τ}^{2}} {S}_{W ( {t}_{i} )}^{( 2 )} ( q ) ;$$

Among them, [symbol] _{\hat{P}}(q, tᵢ) represents a spatio-temporal kernel density of i-th timestamp, tₚ represents a timestamp of a spatio-temporal data point, d(tᵢ, tₚ) represents a Euclidean distance between tᵢ and t_{py}, w represents a normalization constant,

$${S}_{W ( {t}_{i} )}^{( 0 )}$$

represents a window matrix that u equals to 0,

$${S}_{W ( {t}_{i} )}^{( 1 )}$$

represents a window matrix that u equals to 1, and

$${S}_{W ( {t}_{i} )}^{( 2 )}$$

represents a window matrix that u equals to 2.

Each prefix matrix has a corresponding endpoint on a time axis, and according to a certain temporal bandwidth, a window matrix can be constructed between two endpoints, and the spatio-temporal kernel density corresponding to the N temporal bandwidths on the current time axis can be calculated through the window matrix.

Furthermore, when the temporal kernel function (temporal bandwidth) is greater than 0, for each time axis, the spatio-temporal kernel density results on the time axis in the target region can be calculated. This process is the conventional spatio-temporal kernel density visualization:

$${K}_{time} ( {t}_{i} , {t}_{p} ) = \{ \begin{matrix}1 - \frac{1}{{b}_{τ}^{2}} {d ( {t}_{i} , {t}_{p} )}^{2} , & if d ( {t}_{i} , {t}_{p} ) \leq {b}_{τ} \\ 0 , & otherwise\end{matrix} ;$$

Among them, Kₜᵢₘₑ(tᵢ, tₚ) represents a temporal kernel function, tᵢ represents a timestamp corresponding to the i-th window matrix, d(tᵢ, tₚ) represents a Euclidean distance between tᵢ and tₚ, and b_{τ} represents standard temporal bandwidth value.

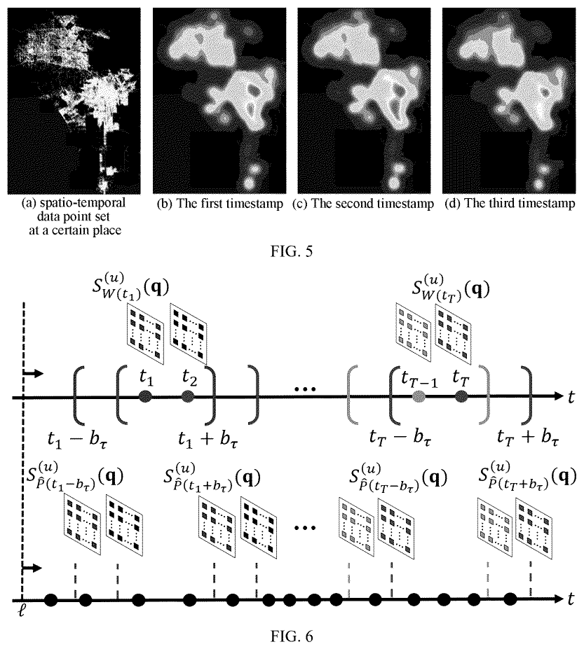

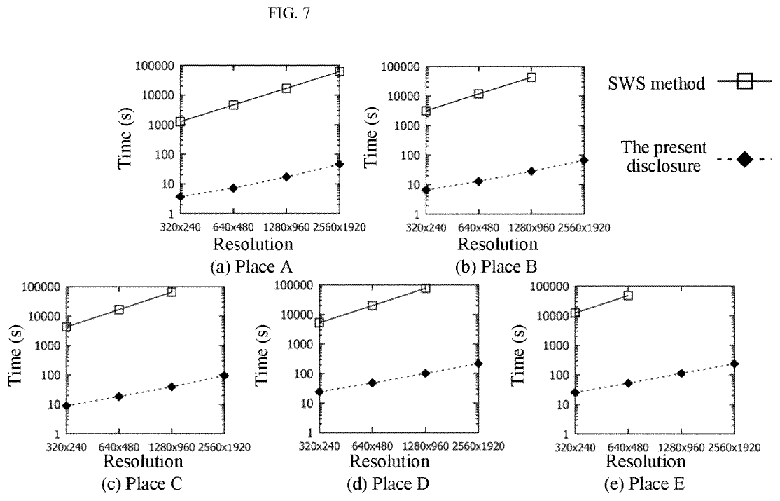

As shown in FIG. 6, the same greyscale represents two endpoints that construct one window matrix, and what is obtained is the total response time of the conventional spatio-temporal kernel density visualization of the timestamp T=32 when the resolution X×Y is changed in different regions ((a) Place A, (b) Place B, (c) Place C, (d) Place D and (e) Place E in FIG. 7 correspond to (a) Place A, (b) Place B, (c) Place C, (d) Place D and (e) Place E in FIG. 4 respectively). If the time complexity and space complexity of the conventional spatio-temporal kernel density visualization are further calculated, that is, the time complexity of the prefix matrix corresponding to each of the time axes (or each of the timestamps) is calculated (this process is to repeatedly calculate the exploratory spatio-temporal kernel density visualization problem based on the number of timestamps), the second time complexity is obtained, and the time complexity calculated based on the data structure of the prefix matrix is O(XYT+Yn) (second time complexity), while the time complexity calculated using the SWS method (sliding window method) in the prior art is O(XY(T+n)), and the space complexity of the two is the same, both are O(XYT+n), so the calculation process based on the prefix matrix takes into account both the temporal and spatial dimensions, and achieves the effect of efficiency optimization.

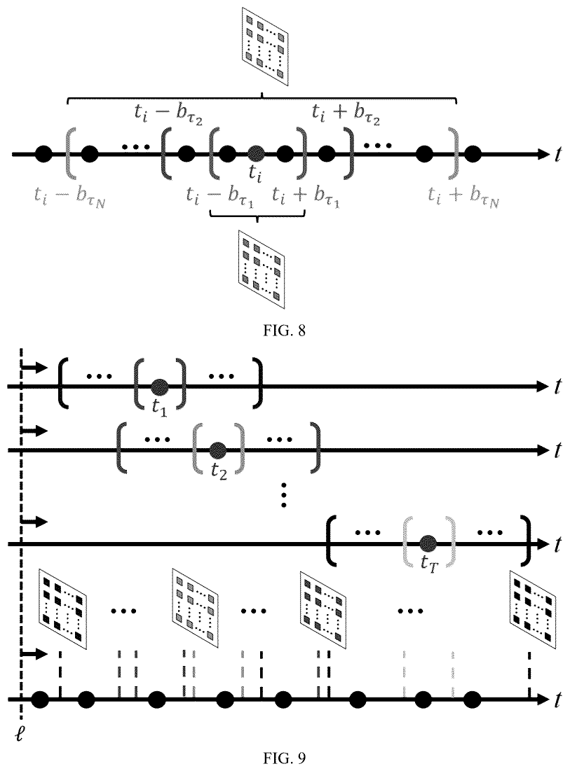

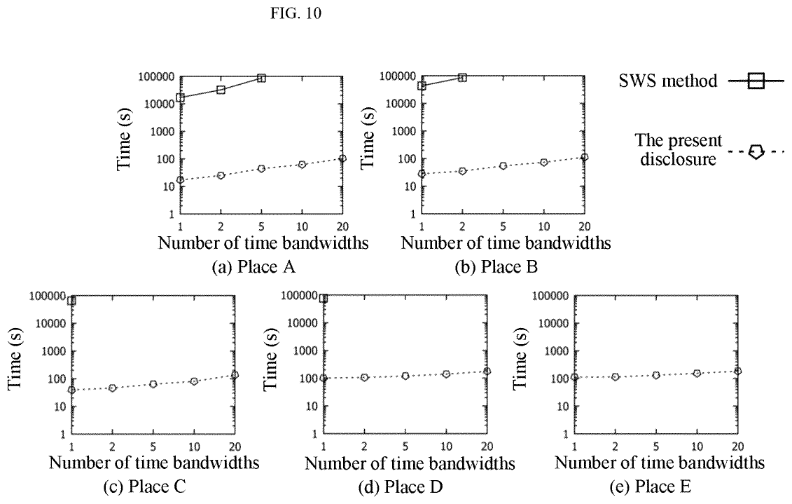

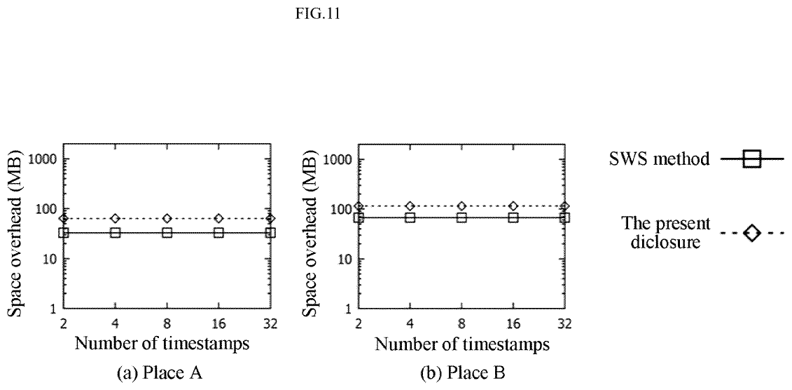

Furthermore, as shown in FIG. 8, based on the constraint information input by a user, a spatial bandwidth is first fixed, then all prefix matrices (including prefix matrices for each timestamp) corresponding to N temporal bandwidths are calculated. Furthermore, as shown in FIG. 9, this can be expanded for a plurality of timestamps (T timestamps). In this case, only L=2TN prefix matrices need to be established (2TN prefix matrices for T timestamps). Then, the total response time for the spatio-temporal kernel density visualization of fixed spatial bandwidths for different spatial bandwidths is calculated iteratively for M times (as shown in FIG. 10, where (a) Place A, (b) Place B, (c) Place C, (d) Place D and (e) Place E in FIG. 10 correspond to (a) Place A, (b) Place B, (c) Place C, (d) Place D and (e) Place E in FIG. 4 respectively) (where FIG. 8 represents one axis of FIG. 9). Therefore, when a spatial bandwidth b_{σ} is fixed, the time complexity of generating these matrices is O(XYTN+Yn), and then the time complexity of calculating the spatio-temporal kernel density based on these matrices is O(XYTN). For the calculation process of each spatial bandwidth, the time complexity of the plurality of prefix matrices corresponding to each of the spatial bandwidths and each of the temporal bandwidths is calculated to obtain the third time complexity, and then the total time complexity O(M(XYTN+Yn)) (third time complexity) can be obtained. The total time complexity calculated using the SWS method is O(MNXY(T+n)), and the space complexity calculated by the two methods is both O(MNXYT+n).

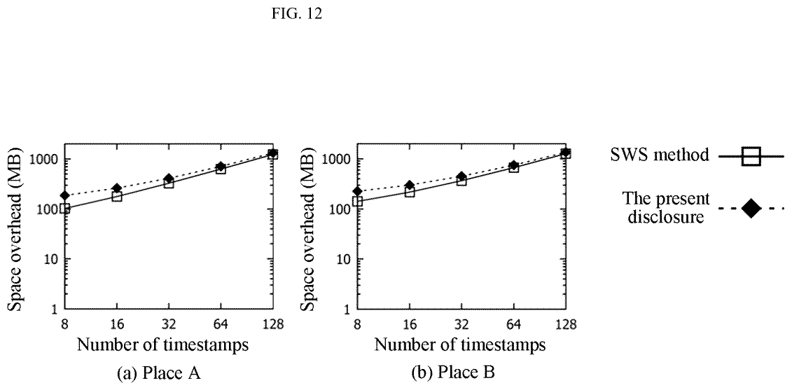

For example, in the present embodiment, when testing five large-scale data sets (up to 5 million data points), the calculation method based on prefix matrix is 115 to 1906 times faster than the advanced SWS method in the prior art (as shown in FIG. 4, FIG. 7, and FIG. 10), while the space overhead is only 1.067 to 1.92 times more than SWS (as shown in FIG. 11 and FIG. 12, (a) Place A in FIG. 11 represents the space overhead of exploratory spatio-temporal kernel density visualization in the first region, (b) Place B in FIG. 11 represents the space overhead of exploratory spatio-temporal kernel density visualization in the second region, (a) Place A in FIG. 12 represents the space overhead of conventional spatio-temporal kernel density visualization in the first region, and (b) Place B in FIG. 12 represents the space overhead of conventional spatio-temporal kernel density visualization in the second region). When the resolution is X×Y=1280×960, and the data points reach the million level, the value of XYn can reach one trillion. Therefore, the technical features of the present solution can simultaneously support high-resolution spatio-temporal kernel density visualization and large-scale data sets, significantly improving the computational efficiency of spatio-temporal kernel density.

Step S40: Coloring each pixel-timestamp pair in the pixel set to obtain a spatio-temporal kernel density visualization result of the target region.

The pixel-timestamp pairs in each prefix matrix are filled with colors, and the spatio-temporal kernel density of the target region is calculated to visualize the spatio-temporal kernel density of the target region.

Two prefix matrices corresponding to each window matrix are determined according to a plurality of temporal bandwidths; each pixel-timestamp pair in the pixel set in each prefix matrix is filled with color to obtain a spatio-temporal kernel density visualization result of the target region.

Spatio-temporal kernel density visualization is a very slow tool. When the number of data points is 1.67 million, it takes at least three hours to generate a spatio-temporal kernel density visualization with a resolution of X×Y=480×320 and a timestamp of 32 using the fastest SWS algorithm. Therefore, the present disclosure adopts a prefix matrix structure to not only significantly improve the visualization efficiency, but also effectively support the bandwidth tuning of spatio-temporal kernel density visualization, find the optimal temporal bandwidth and spatial bandwidth, and significantly improve the performance of spatio-temporal kernel density visualization.

The present disclosure, through the use of a prefix matrix structure, addresses the issues of exploratory and conventional spatio-temporal kernel density visualization as well as bandwidth tuning, thereby generating different numbers of prefix matrices and performing coloring to realize the spatio-temporal kernel density visualization. This reduces the time complexity in the computational process while maintaining a comparable space complexity, takes both temporal and spatial dimensions into account, and improves the efficiency of map visualization.

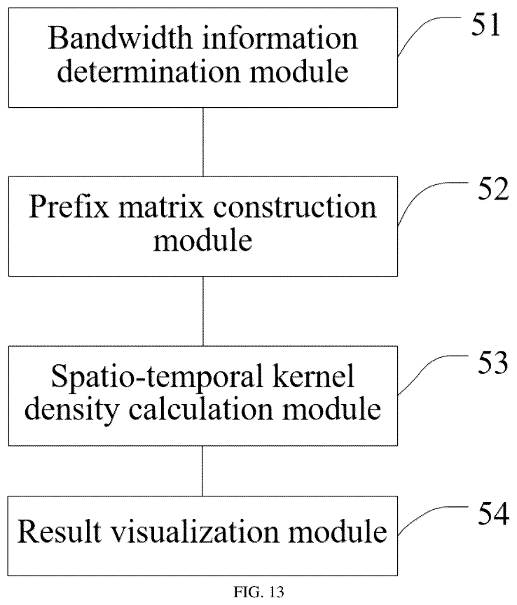

Furthermore, as shown in FIG. 13, based on the above-mentioned method for spatio-temporal kernel density visualization based on prefix matrix, the present disclosure also provides a system for spatio-temporal kernel density visualization based on prefix matrix, which includes:
A bandwidth information determination module 51, configured to acquire constraint information input by a user, determine a first preset group of timestamps according to the constraint information, determine a corresponding time axis according to each of the timestamps, and determine a second preset group of temporal bandwidths on each of the time axes according to the constraint information;
A prefix matrix construction module 52, configured to obtain a pixel set corresponding to each timestamp in a target region, and construct a plurality of prefix matrices according to each pixel set and all the temporal bandwidths on each time axis;
A spatio-temporal kernel density calculation module 53, configured to construct a plurality of window matrices according to the plurality of prefix matrices, and calculate a spatio-temporal kernel density of the target region according to all the window matrices;
A result visualization module 54, configured to color each pixel-timestamp pair in the pixel set to obtain a spatio-temporal kernel density visualization result of the target region.

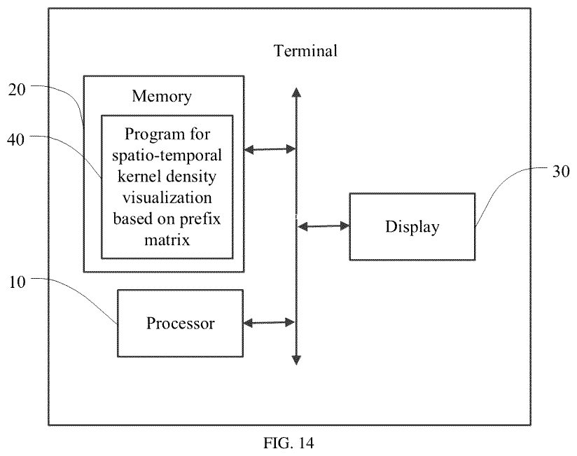

Furthermore, as shown in FIG. 14, according to the method and system for spatio-temporal kernel density visualization based on prefix matrix, the present disclosure also provides a terminal, which includes a processor 10, a memory 20, and a display 30. FIG. 14 shows only some components of the terminal, but it should be understood that it is not required to implement all of the components shown, and more or fewer components may be implemented instead.

In some embodiments, the memory 20 may be an internal storage unit of the terminal, such as a hard disk or memory of the terminal. In other embodiments, the memory 20 may also be an external storage device of the terminal, such as a plug-in hard disk, a smart media card (SMC), a secure digital (SD) card, and a flash card equipped on the terminal. Furthermore, the memory 20 may also include both an internal storage unit of the terminal and an external storage device. The memory 20 is used to store application software and various types of data installed on the terminal, such as the program code of the installation terminal. The memory 20 may also be used to temporarily store data that has been output or is to be output. In one embodiment, a program 40 for spatio-temporal kernel density visualization based on prefix matrix is stored on the memory 20, and the program 40 for spatio-temporal kernel density visualization based on prefix matrix can be executed by the processor 10, thereby realizing the method for spatio-temporal kernel density visualization method based on prefix matrix in the present disclosure.

In some embodiments, the processor 10 may be a central processing unit (CPU), a microprocessor, or other data processing chip, configured to execute program codes or process data stored in the memory 20, such as executing the method for spatio-temporal kernel density visualization based on prefix matrix.

In some embodiments, the display 30 may be an LED display, a liquid crystal display, a touch-sensitive liquid crystal display, or an OLED (Organic Light-Emitting Diode) touchscreen. The display 30 is configured to display information on the terminal and to display a visual user interface. The components of the terminal communicate with each other via a system bus.

In one embodiment, when the processor 10 executes the program 40 for spatio-temporal kernel density visualization based on prefix matrix in the memory 20, the steps of the method for spatio-temporal kernel density visualization based on prefix matrix described above are implemented.

The present disclosure also provides a computer-readable storage medium, and the computer-readable storage medium stores a program for spatio-temporal kernel density visualization based on prefix matrix, and when the program for spatio-temporal kernel density visualization based on prefix matrix is executed by a processor, the steps of the method for spatio-temporal kernel density visualization based on prefix matrix as described above are implemented.

In summary, the present disclosure provides a method and related equipment for spatio-temporal kernel density visualization based on prefix matrix. The method includes: acquiring constraint information input by a user, determining a first preset group of timestamps according to the constraint information, determining a corresponding time axis according to each of the timestamps, and determining a second preset group of temporal bandwidths on each of the time axes according to the constraint information; obtaining a pixel set corresponding to each timestamp in a target region, and constructing a plurality of prefix matrices according to each pixel set and all the temporal bandwidths on each time axis; constructing a plurality of window matrices according to the plurality of prefix matrices, and calculating a spatio-temporal kernel density of the target region according to all the window matrices; and coloring each pixel-timestamp pair in the pixel set to obtain a spatio-temporal kernel density visualization result of the target region. Through the use of prefix structure, the present disclosure addresses issues in exploratory and conventional spatio-temporal kernel density visualization as well as bandwidth tuning, thereby generating different numbers of prefix matrices and performing coloring to achieve spatio-temporal kernel density visualization. This reduces the time complexity during calculation while maintaining a reasonable space complexity, takes both temporal and spatial dimensions into consideration, and improves the efficiency of map visualization.

It should be noted that as used herein, the terms “comprise” “include” or any other variation thereof are intended to cover a non-exclusive inclusion, such that a process, method, article, or terminal including a list of elements not only includes those elements, but may also include other elements not expressly listed, or may include elements inherent to such process, method, article, or terminal. Without further limitation, an element defined by the phrase “comprising . . . ” does not exclude the presence of additional identical elements in the process, method, article, or terminal that comprises the element.

It will be understood by those skilled in the art that all or part of the steps in the above-described embodiments may be implemented by a computer program that instructs related hardware (such as a processor, a controller, and the like) to perform the method. The program may be stored on a computer-readable storage medium, which may be, for example, a memory, a magnetic disk, an optical disk, and the like. When executed, the program may include the steps of the method embodiments described above.

It should be further understood that the application of the present invention is not limited to the examples described above. For a person of ordinary skill in the art, various modifications or variations can be made in light of the above description. All such modifications and variations shall fall within the scope of the appended claims of the present invention.

What is claimed is:

1. A method for spatio-temporal kernel density visualization based on prefix matrix, wherein the method comprises:
acquiring constraint information input by a user, determining a first preset group of timestamps according to the constraint information, determining a corresponding time axis according to each of the timestamps, and determining a second preset group of temporal bandwidths on each of the time axes according to the constraint information;
obtaining a pixel set corresponding to each timestamp in a target region, and constructing a plurality of prefix matrices according to each pixel set and all the temporal bandwidths on each time axis;
wherein the step of obtaining a pixel set corresponding to each timestamp in a target region, and constructing a plurality of prefix matrices according to each pixel set and all the temporal bandwidths on each time axis, further comprises:
obtaining a pixel set corresponding to each timestamp in the target region, and extracting all pixels in each pixel set;
constructing a plurality of pixel-timestamp pairs according to all the pixels and the fourth preset group of endpoints on each of the time axes; and
constructing a prefix matrix corresponding to each endpoint according to all the pixel-timestamp pairs:
$${S}_{\hat{P} ( {t}^{( v )} )}^{( u )} ( q ) = {\sum }_{( p , {t}_{p} ) ∈ \hat{P} ( {t}^{( v )} )} {t}_{p}^{u} \cdot {K}_{space} ( q , p ) ;$$
$$\hat{P} ( {t}^{( v )} ) = \{ ( p , {t}_{p} ) ∈ \hat{P} : {t}_{p} \leq {t}^{( v )} \} ;$$
wherein, q represents a pixel position of the prefix matrix, \hat{P} represents an entire spatio-temporal data point set, (p, tₚ) represents a data point in \hat{P}, t^{(v)} represents a timestamp corresponding to the v-th pixel-timestamp pair, v represents a quantity of timestamps, u represents a constant whose value is determined by a temporal kernel function,
$${t}_{p}^{u}$$
represents tₚ raised to u-th power,
$${S}_{\hat{P} ( {t}^{( v )} )}^{( u )} ( q )$$
represents a prefix matrix of t^{(v)}-th timestamp, p represents a position of (p, tₚ), tₚ represents a timestamp of (p, tₚ), K_{space}(q,p) represents a spatial kernel function, and \hat{P}(t^{(v)}) represents a spatio-temporal data point set that tₚ≤t^{(v)};
constructing a plurality of window matrices according to the plurality of prefix matrices, and calculating a spatio-temporal kernel density of the target region according to all the window matrices; and
coloring each pixel-timestamp pair in the pixel set to obtain a spatio-temporal kernel density visualization result of the target region.

2. The method according to claim 1, wherein the step of acquiring constraint information input by a user, determining a first preset group of timestamps according to the constraint information, determining a corresponding time axis according to each of the timestamps, and determining a second preset group of temporal bandwidths on each of the time axes according to the constraint information, further comprises:
acquiring constraint information input by a user, the constraint information is configured to define a quantity of timestamps in the target region, and a quantity of spatial bandwidths and temporal bandwidths for each timestamp;
determining the first preset group of timestamps in the target region according to the constraint information, and determining the corresponding time axis according to each of the timestamps; and
determining the second preset group of temporal bandwidths and a third preset group of spatial bandwidths on each of the time axes according to the constraint information.

3. The method according to claim 2, wherein the step of determining the second preset group of temporal bandwidths and a third preset group of spatial bandwidths on each of the time axes according to the constraint information, further comprises:
fixing a single spatial bandwidth, and determining the second preset group of temporal bandwidths on each of the time axes according to the second preset group of temporal bandwidths; and
determining a fourth preset group of endpoints according to all the temporal bandwidths.

4. The method according to claim 1, wherein the step of constructing a plurality of window matrices according to the plurality of prefix matrices, and calculating a spatio-temporal kernel density of the target region according to all the window matrices, further comprises:
constructing the plurality of window matrices according to the fourth preset group of prefix matrices on each time axis:
$${S}_{W ( {t}_{i} )}^{( u )} ( q ) = {S}_{\hat{P} ( {t}_{i} + {b}_{τ} )}^{( u )} ( q ) - {S}_{\hat{P} ( {t}_{i} - {b}_{τ} )}^{( u )} ( q ) ;$$
$$wherein , {S}_{W ( {t}_{i} )}^{( u )} ( q )$$
represents a window matrix used to calculate the spatio-temporal kernel density, u represents a constant whose value is determined by a temporal kernel function,
$${S}_{\hat{P} ( {t}_{i} + {b}_{τ} )}^{( u )} ( q ) and {S}_{\hat{P} ( {t}_{i} - {b}_{τ} )}^{( u )} ( q )$$
represent prefix matrices of two endpoints in tᵢ-th timestamp when temporal bandwidth is b_{τ}, b_{τ} represents a temporal bandwidth, and tᵢ represents a timestamp corresponding to i-th window matrix; and
calculating the spatio-temporal kernel density of the target region based on all the window matrices:
$${\hat{P}}_{} ( q , {t}_{i} ) = {\sum }_{( p , {t}_{p} ) ∈ \hat{P}} w \cdot {K}_{space} ( q , p ) \cdot ( 1 - \frac{1}{{b}_{τ}^{2}} {d ( {t}_{i} , {t}_{p} )}^{2} ) = w \cdot ( 1 - \frac{{t}_{i}^{2}}{{b}_{τ}^{2}} ) {S}_{W ( {t}_{i} )}^{( 0 )} ( q ) + \frac{2 {wt}_{i}}{{b}_{τ}^{2}} {S}_{W ( {t}_{i} )}^{( 1 )} ( q ) - \frac{w}{{b}_{τ}^{2}} {S}_{W ( {t}_{i} )}^{( 2 )} ( q ) ;$$
wherein, [symbol] _{\hat{P}}(q, tᵢ) represents a spatio-temporal kernel density of i-th timestamp, tₚ represents a timestamp of a spatio-temporal data point, d(tᵢ, tₚ) represents a Euclidean distance between tᵢ and tₚ, w represents a normalization constant,
$${S}_{W ( {t}_{i} )}^{( 0 )}$$
represents a window matrix that u equals to 0,
$${S}_{W ( {t}_{i} )}^{( 1 )}$$
represents a window matrix that u equals to 1, and
$${S}_{W ( {t}_{i} )}^{( 2 )}$$
represents a window matrix that u equals to 2.

5. The method according to claim 2, wherein after the step of constructing a plurality of window matrices according to the plurality of prefix matrices, and calculating a spatio-temporal kernel density of the target region according to all the window matrices, further comprises:
calculating a time complexity of the prefix matrix of endpoint on each of the time axis to obtain a first time complexity;
calculating a time complexity of a plurality of prefix matrices corresponding to each of the time axes to obtain a second time complexity; and
calculating a time complexity of a plurality of prefix matrices corresponding to each of the spatial bandwidths and each of the temporal bandwidths to obtain a third time complexity.

6. The method according to claim 4, wherein the step of coloring each pixel-timestamp pair in the pixel set to obtain a spatio-temporal kernel density visualization result of the target region, further comprises:
determining two prefix matrices corresponding to each window matrix according to a plurality of temporal bandwidths; and
coloring each pixel-timestamp pair in the pixel set in each prefix matrix to obtain the spatio-temporal kernel density visualization result of the target region.

7. A system for spatio-temporal kernel density visualization based on prefix matrix, the system is configured to apply the steps of the method for spatio-temporal kernel density visualization based on prefix matrix according to claim 1, wherein the system comprises:
a bandwidth information determination module, configured to acquire constraint information input by a user, determine a first preset group of timestamps according to the constraint information, determine a corresponding time axis according to each of the timestamps, and determine a second preset group of temporal bandwidths on each of the time axes according to the constraint information;
a prefix matrix construction module, configured to obtain a pixel set corresponding to each timestamp in a target region, and construct a plurality of prefix matrices according to each pixel set and all the temporal bandwidths on each time axis;
a spatio-temporal kernel density calculation module, configured to construct a plurality of window matrices according to the plurality of prefix matrices, and calculate a spatio-temporal kernel density of the target region according to all the window matrices; and
a result visualization module, configured to color each pixel-timestamp pair in the pixel set to obtain a spatio-temporal kernel density visualization result of the target region.

8. A terminal, wherein the terminal comprises: a memory, a processor, and a program for spatio-temporal kernel density visualization based on prefix matrix stored on the memory, the program is executable on the processor, when the program for spatio-temporal kernel density visualization based on prefix matrix is executed by the processor, the steps of the method for spatio-temporal kernel density visualization based on prefix matrix according to claim 1 are implemented.
